(19) United States
(12) Patent Application Publication
(10) Pub. No.: US 2016/0159266 A1
(43) Pub. Date: Jun. 9, 2016

(54) VEHICLE, FACILITY AND STATIONS FOR LOADING AND UNLOADING A CONTAINER

(71) Applicant: BATTERIE MOBILE, Hericourt (FR)

(72) Inventors: Stephane HECKY, Belfort (FR); Simon KLEIN, La-Chapelle-Sous-Rougemont (FR)

(21) Appl. No.: 14/901,067

(22) PCT Filed: Jun. 20, 2014
(86) PCT No.: PCT/FR2014/051546

§ 371 Date: Jan. 27, 2016

(30) Foreign Application Priority Data
Jun. 28, 2013 (FR) 1356288
Oct. 21, 2013 (FR) 1360245

(51) Int. Cl. B60P 1/64; A47F 7/28; B60P 1/02

(52) U.S. Cl. CPC B60P 1/6445; B60P 1/02; A47F 7/28

(57) ABSTRACT

The invention relates to a vehicle (1) for transporting a container (2), comprising a chassis (3) supported on two axles (40) and capable of receiving at least one container (2), wherein said chassis (4) is further provided with wedges (5) for laterally retaining the container (2), characterized in that said wedges are provided in the form of a protrusion member on the side of the side-members (30) of said chassis (3), in that the rails (70) include, at the bearing surfaces (71) thereof, openings (73) for said side retaining wedges (5) to pass through, wherein the chassis (3) has a width smaller than that of a container (2) so has to pass between two bearing ramps for loading and unloading a container (2). The invention also relates to a facility comprising a plurality of stations and a station base module.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

1. Field of the Invention

The present invention falls within the field of handling containers in port, airport, railroad, road or mixed facilities.

The invention is preferably, but non-limitingly, applicable to the transportation, storage and handling of containers within a port zone.

To that end, the invention relates to a vehicle for transporting containers, as well as a facility for loading and unloading containers, and a module with two loading and unloading stations.

2. Description of Related Art Including Information Disclosed Under 37 CFR 1.97 and 37 CFR 1.98.

In a known manner, a container is an enclosure with standardized dimensions, assuming the form of a parallelepiped block and making it possible to load goods therein for storage and transport, in particular by sea on boats called “container ships”.

More specifically, such a container comprises a rectangular parallelepiped structure, each corner of which is equipped with a standardized steel corner, called “ISO corner”, connecting vertical metal uprights. Thus, it is possible to stack several containers on top of one another, forming a storage zone. This stacking is done by lifting vehicles from transportation vehicles provided with a platform for receiving one or more containers, and vice versa during unstacking. These operations are carried out by means of a station, or dock, receiving one or more containers so that they can be loaded or unloaded on the platform of a vehicle, or reciprocally during unstacking or stacking from and to the storage zone.

Furthermore, a station is made up of at least two raised guideways extending horizontally, parallel to one another. These guideways have a section provided on the one hand with an inclined approach surface, and on the other hand with bearing surfaces. These guideways are turned toward one another, and spaced apart to receive the standardized width of the containers, in order to form planar lower longitudinal bearing zones on which the containers rest, while guiding it during its insertion owing to said inclined surfaces forming a centering cone.

In both cases, said vehicle becomes placed between and under the guideways. To that end, the station is raised by bases or feet extending vertically and connecting each guideway in the upper portion, at regular intervals. Thus, the vehicle can position itself below the guideways, in order to load or unload its containers.

Because the station is raised, a lift table is mounted on the chassis of the vehicle, said lift table being motorized so as to go from a lower position to an upper position and vice versa. In the lower position, the height of the chassis allows it to pass below the guideways, whereas in the upper position, the vertical travel of said table allows it to come above said guideways. For such reasons, this table is defined as having a width smaller than the separation of the guideways, and consequently, smaller than that of a container.

More particularly, during the loading of at least one container deposited beforehand on the guideways of the station, the vehicle positions itself within the station, below the guideways. Then, its lift table is actuated to raise and lift the container, by passing between the guideways, said container then no longer resting on the guideways, since it is supported by the table. Next, this vehicle leaves the station and lowers its platform again.

During unloading, before positioning itself within the station, the vehicle lifts its table and the container resting on top of it. It then parks its chassis below the guideways to next lower said table again to the lower position, thus allowing the container to rest on the guideways. Lastly, it leaves again empty, with its platform lowered.

Such a design consequently requires equipping the chassis of the vehicle with a lift table designed, like said chassis, to have a sufficient mechanical strength to be able to handle a container and the weight that it represents. This results in a significant increase in the total weight of the vehicle, compared with a vehicle with no lift table. Such an excess weight has a direct impact on the transportation capacity of the vehicle, and all of these components must also be sized to account for this additional weight. This excess weight also affects the movement speed of the vehicle, this speed then even being limited when it does not bear a load and moves empty.

Furthermore, in this case, the chassis is provided with lateral retaining wedges, between which the container fits when the lift table is in the lower position, to guarantee the maintenance of the container during the movement phases of the vehicle. As a result, said wedges protrude from the width of the chassis and are present on either side of the container.

To be able to pass in the guideways of the station, these wedges cannot follow the elevation movement produced by the table. In other words, when the table is raised and loaded, in particular in the approach phase for unloading and the exit phase after loading, the container is not maintained laterally, not providing any stability and increasing the risk of spills.

One example of such a solution is described in document WO 2008/046728, targeting a vehicle designed to receive two containers on two lift platforms, aligned longitudinally, mounted vertically movable on a rolling chassis, from a lower position to an upper position and vice versa. Furthermore, in the lower position, the chassis comprises lateral maintaining means for the containers, in the form of members secured to said chassis and extending while protruding vertically, on either side of each platform. Lastly, each platform comprises, at only one of its distal ends, wedges ensuring proper longitudinal positioning of the container, in particular during handling thereof.

Such a vehicle is designed to cooperate with a container loading and unloading dock. Such a dock has lateral guideways, configured in an L shape and in opposition, designed to receive a container while supporting it from below. A container can be lifted by the platform of the vehicle parked below it, then moved into the upper position, so as lastly to be lowered and maintained laterally by said members, but only in the lowered position of said platform, and vice versa. No lateral maintenance of the container is provided during its raising and lowering phases.

Another solution is described in document U.S. Pat. No. 2,379,094, targeting a similar vehicle with a rear lift platform, to go from an upper position to a lower position and vice versa. This platform comprises a removable plate. This platform can cooperate with a loading dock having guideways in the form of right-angled corners, configured in an L shape. In particular, the plate can be deposited or recovered on and from said dock, respectively. Furthermore, said plate comprises side walls, mounted articulated in rotation along a 90° travel, from a raised position in which they extend vertically toward a deployed position in which they extend horizontally, and vice versa. In the deployed position, these lateral walls cover the gap between the edges of the plate and the inner wall of the guideways, when said plate is in its position deposited on the dock.

One can see that the chassis for receiving the removable plate is clearly narrower than said plate. Once again, there is no lateral maintenance of the plate or what it bears during raising and lowering.

### BRIEF SUMMARY OF THE INVENTION

The present invention aims to offset the drawbacks of the state of the art by proposing a vehicle whereof the chassis ensures the lateral maintenance of the container during these raising and lowering steps.

Additionally, such a chassis has no lift table, but is able to perform the functionalities of the latter. In particular, without a lift table, the weight of this vehicle is considerably decreased, making it faster and easier to maneuver.

To that end, such a vehicle includes a chassis resting on rolling means in the form of at least two axles, at least one of which is a steering axle, at least one container being able to rest on said chassis, said chassis also being equipped with lateral retaining wedges for said container, said chassis having a width smaller than that of the container to pass between two loading and unloading support guideways for a container, said two guideways being raised and extending horizontally, parallel to one another, said guideways having a section provided at least with bearing surfaces turned toward one another, in order to establish lower longitudinal planer bearing zones on which the containers rest.

It is characterized by the fact that said wedges assume the form of an element forming a protrusion on the side of the side members of said chassis, in that said guideways include, at their bearing surface, passage openings for said lateral retaining wedges, said chassis including a width smaller than that of a container to pass between two container loading and unloading support ramps.

Alternatively, non-limitingly, said chassis rests on said axles via hydraulic suspension means constituting lifting means for said chassis along a travel greater than 200 millimeters (mm), preferably greater than 500 mm, said chassis including a width smaller than that of the container to pass between two support ramps for loading and unloading the container.

Furthermore, according to another inventive approach considered in a related manner and alternatively, non-limitingly, this chassis is provided with retractable lateral retaining wedges. More specifically, non-limitingly, said lateral retaining wedges can be mounted movably relative to said chassis to go from a deployed position for laterally retaining said container toward a retracted position, and vice versa.

According to one preferred alternative, the guideways of the station include passage openings for lateral retaining wedges provided fixed relative to the chassis of the vehicle, during the lifting and lowering phases of said chassis. Said wedges are stationary, protruding relative to the chassis.

To that end, the invention also relates to a facility for loading and unloading containers using a vehicle according to any one of the preceding claims, including at least one station made up of at least two raised guideways extending horizontally, parallel to one another, said guideways having a section provided at least with bearing surfaces turned toward one another, in order to constitute planer lower longitudinal bearing zones on which the containers rest, characterized in that said guideways include, at their bearing surface, passage openings for said lateral retaining wedges. Thus, the stationary wedges can cross through the guideways for lifting or lowering the lift table of the vehicle.

According to another particularity, the guideways are made up of segments, spaced apart by an interval corresponding at least to the passage width of said wedges, across from the latter. In sum, the guideways are separated, then being similar to studs, distributed regularly and across from one another so as to establish container receiving pairs.

According to another design, the facility can include several juxtaposed stations, each station being made up of at least two raised guideways extending horizontally, parallel to one another, said guideways having a section provided at least with bearing surfaces turned toward one another, in order to constitute planer lower longitudinal bearing zones on which the containers rest. This facility is characterized in that two adjacent stations include a shared base supporting their adjacent guideways. In sum, instead of providing a separate base for each station, two stations share the same base, decreasing the installation bulk needed and increasing the space for the passage of said chassis.

The invention also relates to a station base module for loading and unloading, made up of a post topped by two guideway segments adopting a symmetrical arrangement relative to a vertical median plane.

More specifically, the inclined surfaces of the guideways or guideway segments are positioned back to back, while their bearing surfaces extend outward.

These simply designed modules can be installed, with a selected spacing, to produce adjacent stations quickly.

### BRIEF DESCRIPTION OF THE SEVERAL VIEWS OF THE DRAWINGS

Other features and advantages of the invention will emerge from the following detailed description of non-limiting embodiments of the invention, in reference to the appended figures.

FIG. 1 shows a diagrammatic perspective view of one example embodiment of a facility for loading and unloading containers according to the invention, made up of a plurality of juxtaposed stations, in particular four stations equipped with a module according to the invention.

FIG. 2 shows a diagrammatic vertical cross-sectional view of part of FIG. 1, showing two stations loaded with containers, said stations being equipped at their adjacent guideways with a module according to the invention.

FIG. 3 shows a diagrammatic perspective view of an embodiment in which a single guideway has openings for the passage of said wedges.

FIG. 4 shows a diagrammatic perspective view of one specific embodiment of a vehicle according to the invention.

FIG. 5 shows a diagrammatic top plan view of FIG. 4, in the deployed position of said moving wedges.

FIG. 6 shows a diagrammatic top plan view similar to FIG. 4, in the retracted position of said movable wedges.

FIG. 7 shows a diagrammatic view according to a vertical cross-section of the detail of the chassis, in the deployed position of said moving wedges, when said vehicle is loaded with a container.

FIG. 8 shows a diagrammatic view in vertical cross-section of the detail of the chassis, in the retracted position of said movable wedges, when said vehicle is loaded with a container.

### DETAILED DESCRIPTION OF THE INVENTION

The present invention relates to a vehicle 1 for transporting a container 2.

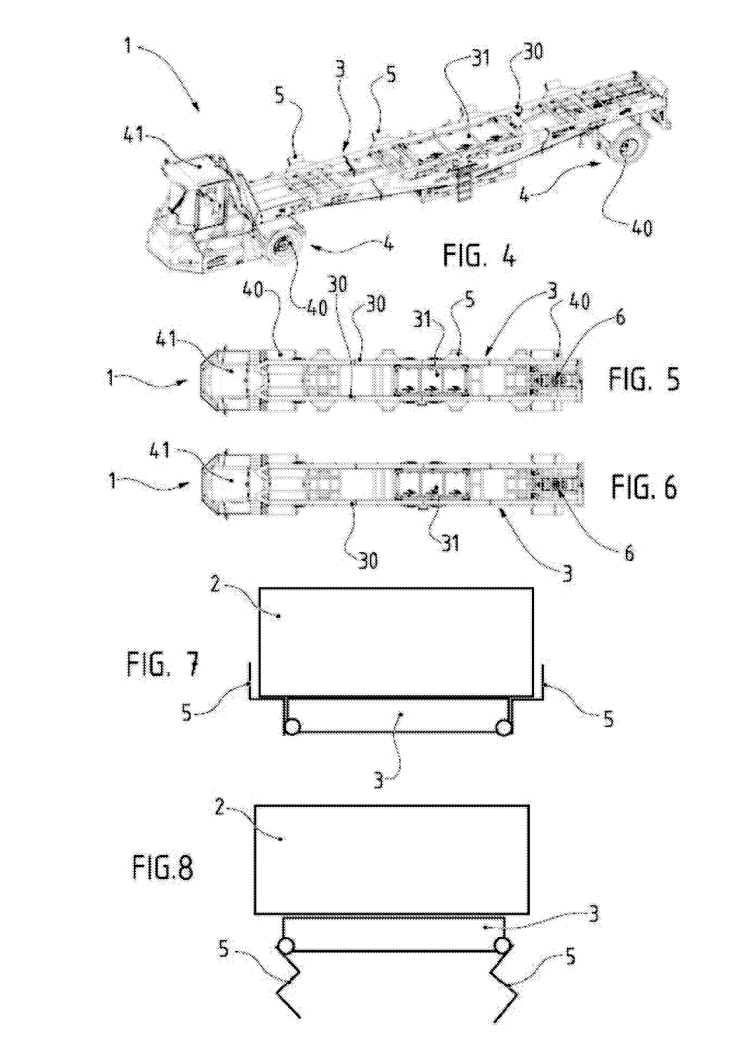

Such a vehicle 1 includes a chassis 3, resting on rolling means 4, in the form of at least two axles 40, at least one of which is a steering axle. According to the embodiment of FIG. 4, such a vehicle 1 comprises a steering axle situated in front, at a steering station in the form of a cabin 41. The axle situated in the rear is then non-steering.

Said chassis 3 also incorporates independent motor means 31, driving the rolling means 4 for the movement of said vehicle 1.

At least one container 2 can rest on this chassis 3. Preferably, the length of said chassis 3 makes it possible to deposit one or more containers 2 on the upper face thereof, based on their length. To that end, the upper face of the chassis 3 then constitutes means for receiving containers 2 comparable to a rear plate.

To that end, according to the preferred embodiment, shown in FIGS. 4 to 6, the chassis 3 is made up of an assembly of spaced apart and reinforced side members 30, ensuring the longitudinal and transverse rigidity of said rear plate, as well as the strength to withstand a load of several containers 2.

Advantageously, said chassis 3 includes a width smaller than that of a container 2 to pass between two support ramps or guideways for loading and unloading of a container 2, in particular at a station 7 for loading and unloading a container 2. In sum, the chassis 3 is dimensioned such that a container 2 protrudes from each side, when it is loaded on the vehicle 1. The container(s) 2 are then only supported from below.

That is why said chassis 3 is also equipped with lateral retaining wedges 5 for said container 2. These wedges 5 extend laterally, in pairs, protruding on either side of said chassis 3, and ensure, by two or four, the maintenance of the container 2 deposited on the rear plate. To that end, said wedges 5 have spaces between them chosen as a function of the standardized length of the different types of containers 2. Their length is also determined to allow containers 2 of different types to be retained.

To that end, it will be noted that the spacing is provided to make it possible to receive a container with standardized side members, namely 20, 30 or 40 inches, i.e., 6058, 3657 or 12,192 millimeters. More specifically, each wedge 5 assumes the form of a member protruding on the side of the side members 30 of said chassis 3. Each wedge 5 is also in the form of a stop, i.e., it has a face connected to the chassis 3 and extending horizontally or substantially horizontally, in the plane of the upper face of said chassis 3, connected to a free end oriented vertically or substantially vertically. The latter ensures the lateral maintenance of the loaded container 2 at the rear of the vehicle 1.

According to one essential feature, the vehicle 1 [is] characterized by the fact that its chassis 3 rests on said axles 40 via hydraulic suspension means 6 constituting means for lifting said chassis 3. This lifting is done over a travel of more than 200 millimeters (mm), preferably more than 500 mm.

In sum, the vehicle 1 does not include a rear platform, mounted on its chassis 3 and able to rise and lower. The chassis 3 directly has a motor, in order to perform the lifting operations, raising and lowering for loading and unloading operations of containers 2. Thus, the design and construction of said chassis 3 is greatly simplified, while decreasing its manufacturing cost, and above all lightening its total weight when unloaded.

According to one particular embodiment, said suspension means 6 assume the form of hydraulic jacks or pistons, at least partially powered by said independent motor means 31.

The travel of said suspension means 6 allows the chassis 6 to rise above the ground so as to exceed the height of the guideways of a loading or unloading station 7 for a container 2.

Consequently, it will be understood that the chassis 3 being able to rise and lower, while the wedges 5 are directly assembled on said chassis 3, the containers 2 that it supports are continuously retained, including during lifting or movement operations of the vehicle 1, while its chassis 3 is in the upper position.

To that end, given that the wedges 5, in the position retaining a container 2, protrude on the sides of the chassis 3, past the width of the containers 2, they no longer allow the passage between the guideways of a station 7.

According to one related and alternative, non-limiting embodiment, the wedges 5 are provided to be retractable, i.e., they can withdraw so as no longer to extend over the sides of said chassis 3.

To that end, said lateral retaining wedges 5 are mounted movably relative to said chassis 3 to go from a deployed lateral retaining position of said container 2 to a retracted position, and vice versa. The deployed position is shown in FIGS. 5 and 7, while the retracted position is shown in FIGS. 6 and 8.

According to one particular configuration, in the retracted position, said wedges 5 are situated within a space defined by the width of the chassis 3.

According to another configuration, in the retracted position, said wedges 5 are retractable below said chassis 3, as shown in FIG. 8.

In this specific embodiment, the wedges 5 are articulated to rotate or pivot, so as to describe a travel following an arc of circle, to rotate and be found, abutting or at the end of travel, below the chassis 3.

According to another preferred embodiment, the wedges 5 can be mounted moving vertically and laterally, in translation, in order to be inserted directly within said chassis 3, in particular within the a housing or spaces arranged to that end.

It is thus possible to pull the wedges 5 in at the last moment, during lifting of the chassis 3, when the vehicle 1 is already parked within the station 7.

According to another possibility, said wedges 5 are provided to be stationary relative to the chassis 3.

It has then been considered to provide holes for the passage of said wedges 5 through the guideways of the station 7, during the raising and lowering thereof.

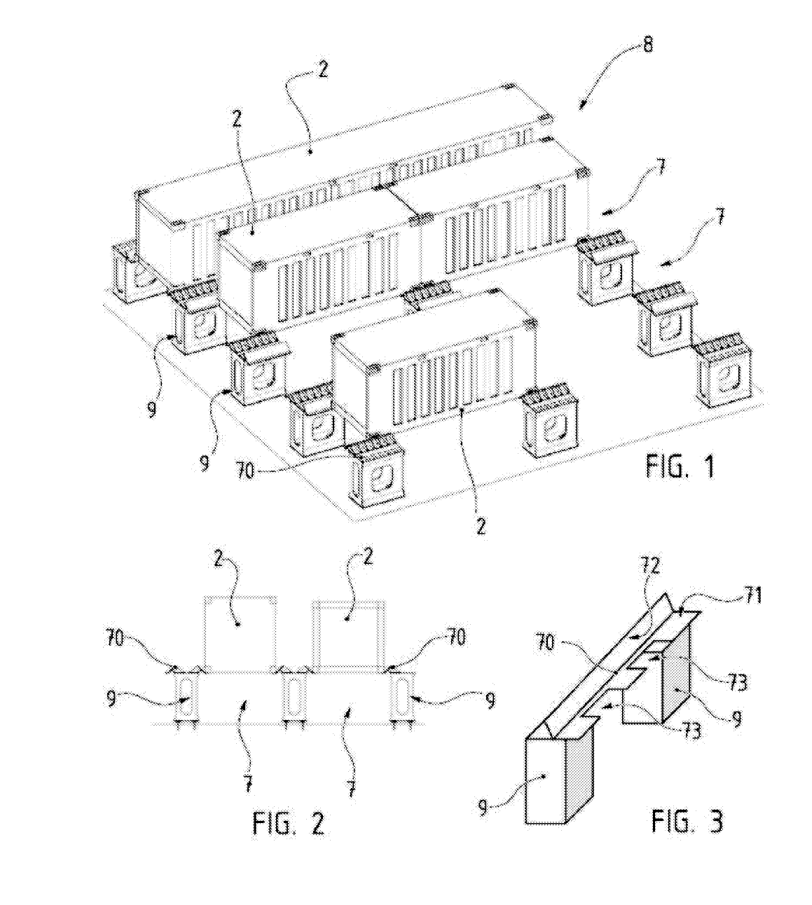

To that end, the invention also relates to a facility 8 for loading and unloading containers 2 using a vehicle 1 as previously described. Such a facility 8, including at least one station 7, preferably several, is shown in FIG. 1.

Each station 7 is made up of at least two raised guideways 70 extending horizontally, parallel to one another. Said guideways 70 have a section provided at least with bearing surfaces 71 turned toward one another, in order to make up planar lower longitudinal bearing zones on which the containers 2 rest. In sum, each container 2 rests at its lower lateral edges on the bearing surfaces 71 of two guideways 70, as shown in FIGS. 1 and 2.

Furthermore, each guideway 70 also includes an inclined surface 72, dedicated to guidance to center the container 2 during its positioning on the station 7. The inclined faces 72 of two guideways 7 situated across from one another are oriented converging from top to bottom.

In the case of fixed wedges 5, said guideways 70 include, at their bearing surface 71, passage openings 73 for said lateral retaining wedges 5 in the deployed position. Such a design is shown in FIG. 3.

According to another configuration, said guideways 70 are made up of segments, spaced apart by an interval corresponding at least to the passage width of said lateral retaining wedges 5. In sum, each guideway 70 is no longer made up of a single longitudinal element or an assembly of longitudinal elements over its entire length, but of longitudinal segments spaced apart from one another.

In this last configuration, each station 7 is then much easier to install, and its cost is decreased.

In this same approach, it has been considered to simplify the facility 8 when it comprises at least two stations 7. To that end, two adjacent stations include a shared base 9 supporting their adjacent guideways 70. In other words, the raising of a pair of guideways 70 (or guideway segment) of two stations 7 situated next to one another is done through a single lifting foot.

Once again, this single base 9 for a station pair 7 makes it possible to simplify the installation, while decreasing costs, as well as by bringing the stations 7 closer to one another, resulting in decreasing the footprint.

From this perspective, the invention also relates to a base module 9 with two adjacent loading and unloading stations 7. Such a module is made up of a post topped by two guideways 7 or at least two guideways segments adopting a symmetrical arrangement relative to a vertical median plane. In particular, the symmetry applies at least to the bearing surfaces 71, which then extend symmetrically on either side of said median plane.

According to the preferred embodiment, the inclined surfaces 72 of said guideways 7 and segments are positioned back to back, while their bearing surfaces 71 extend outwardly. Such a configuration is shown in FIG. 2.

Thus, it is possible to form two stations 7 from a single module forming a joint or shared base 9.

The different systems according to the invention in combination make it possible, by cooperating with one another, to simplify the design and installation of stations 7 and a loading and unloading facility 8 for containers 2. The independent modules allow the creation of stations 7 sharing a same footprint, while creating space between the guideways segments, which is necessary for lifting with stationary wedges 5. Furthermore, it is possible to bring the bases 9 closer together, decreasing the space within which the specific chassis 3 of the vehicle according to the invention must be inserted, while ensuring the raising and lowering of the container. Then, this simplified lifting chassis 3, with no attached platform, performs this maneuver inside such stations 7.

1. A vehicle (1) for transporting containers (2), including a chassis (3) resting on rolling means (4) in the form of at least two axles (40), at least one of which is a steering axle, at least one container (2) being able to rest on said chassis (3), said chassis (4) also being equipped with lateral retaining wedges (5) for said container (2), said chassis (3) having a width smaller than that of a container (2) to pass between two loading and unloading support guideways for a container (2), said two guideways (70) being raised and extending horizontally, parallel to one another, said guideways (70) having a section provided at least with bearing surfaces (71) turned toward one another, in order to establish lower longitudinal planer bearing zones on which the containers (2) rest, characterized in that said wedges assume the form of an element forming a protrusion on the side of the side members (30) of said chassis (3), in that said guideways (70) include, at their bearing surface (71), passage openings (73) for said lateral retaining wedges (5), said chassis (3) including a width smaller than that of a container (2) to pass between two container (2) loading and unloading support ramps.

2. The vehicle according to claim 1, characterized in that said chassis (3) rests on said axles (40) via hydraulic suspension means (6) constituting lifting means for said chassis (3) along a travel greater than 200 millimeters (mm), preferably greater than 500 mm.

3. The vehicle (1) according to claim 1, characterized in that said lateral retaining wedges (5) are mounted fixed relative to said chassis (3).

4. A facility (8) for loading and unloading containers using a vehicle according to any one of the preceding claims, including at least one station (7) made up of at least two raised guideways (70) extending horizontally, parallel to one another, said guideways (70) having a section provided at least with bearing surfaces (71) turned toward one another, in order to constitute planer lower longitudinal bearing zones on which the containers (2) rest, characterized in that said guideways (70) include, at their bearing surface (71), passage openings (73) for said lateral retaining wedges (5).

5. The facility (8) for loading and unloading containers using a vehicle (1) according to any one of the preceding claims, including at least one station (7) made up of at least two raised guideways (70) extending horizontally, parallel to one another, said guideways (70) having a section provided at least with bearing surfaces (71) turned toward one another, in order to form planar lower longitudinal bearing zones on which the containers (2) rest, characterized in that said guideways (70) are made up of segments, spaced apart by an interval corresponding at least to the passage width of said lateral retaining wedges (5).

6. A facility (8) including several juxtaposed stations, each station being made up of at least two raised guideways (70) extending horizontally, parallel to one another, said guideways (70) having a section provided at least with bearing surfaces (71) turned toward one another, in order to constitute planer lower longitudinal bearing zones on which the containers (2) rest, characterized in that two adjacent stations (7) include a shared base (9) supporting their adjacent guideways (70).

7. A station base module (9) with two adjacent loading and unloading stations (7), made up of a post topped by two guideways (70) or at least two guideway segments adopting a symmetrical arrangement relative to a vertical median plane.

8. The base module (9) according to claim 7, characterized in that the inclined surfaces (72) of said guideways or guideway segments are positioned back to back, while their bearing surfaces (71) extend outward.
